(19) United States
(12) Patent Application Publication
(10) Pub. No.: US 2021/0003436 A1
(43) Pub. Date: Jan. 7, 2021

(54) TIME-OF-FLIGHT GENERATING CIRCUIT AND CHIP, FLOW METER AND METHOD OF THE SAME

(71) Applicant: SHENZHEN GOODIX TECHNOLOGY CO., LTD., GUANGDONG (CN)

(72) Inventors: YEN-YIN HUANG, GUANGDONG (CN); JUNG-YU CHANG, GUANGDONG (CN)

(21) Appl. No.: 17/028,931

(22) Filed: Sep. 22, 2020

Related U.S. Application Data
(63) Continuation of application No. PCT/CN2019/078812, filed on Mar. 20, 2019.

(51) Int. Cl. G01F 1/66; G08C 23/02

(52) U.S. Cl. CPC G01F 1/667; G08C 23/02

(57) ABSTRACT

The application discloses a time-of-flight (TOF) generating circuit (100), coupled to a first transducer (102) and a second transducer (104), wherein the first transducer and the second transducer are arranged in a pipeline (120) filled with fluid. The TOF generating circuit includes a first transmitter (106) and a first receiver (108), a second transmitter (110) and a second receiver (112), a signal generating circuit (114), a correlation circuit (116), and a processing circuit (118). Under different ambient factors, the signal generating circuit generates, respectively, a first signal and a second signal, which are received by the second receiver and the first receiver to generate a first receiving signal (RS1) and a second receiving signal (RS2), respectively. The correlation circuit performs a correlation operation to generate a first correlation signal (CS1). The processing circuit generates the TOF variation according at least to the first correlation signal (118).

### CROSS-REFERENCE TO RELATED APPLICATIONS

This application is a continuation of International Application No. PCT/CN2019/078812, filed on Mar. 20, 2019, the disclosure of which is hereby incorporated by reference in its entirety.

### TECHNICAL FIELD

The present application relates to a time-of-flight generating circuit and chip, flow meter, and method of the same.

### BACKGROUND

Ultrasonic flow meters are commonly used flow meters. Flow meters are widely applied in detecting the flow speed of a fluid; compared with other types of flow meters, ultrasonic flow meters have greater advantages in aspects like pressure loss, lowest detectable flow speed and installation cost; however, due to the complexity of the calculation, the accuracy thereof still needs to be improved, and therefore, further improvement and innovation thereto are necessary.

### SUMMARY OF THE INVENTION

One purpose of the present application is to disclose a time-of-flight (TOF) generating circuit and related chip, flow meter, and method of the same to address the above-mentioned issues.

One embodiment of the present application discloses a TOF generating circuit, coupled to a first transducer and the second transducer, wherein there is a distance greater than zero between the first transducer and the second transducer, and the first transducer and the second transducer are arranged in a pipeline filled with fluid. The TOF generating circuit includes a first transmitter and a first receiver coupled to the first transducer, a second transmitter and a second receiver coupled to the second transducer, a signal generating circuit, a correlation circuit, and a processing circuit. The signal generating circuit is configured to, under a first ambient factor, generate a first signal to the first transmitter to cause the first transducer to transmit a first transducer signal, wherein the first transducer signal is received by the second transducer, and the second receiver generates a first receiving signal to the signal generating circuit; and, under a second ambient factor, generate a second signal to the first transmitter to cause the first transducer to transmit a second transducer signal, wherein the second transducer signal is received by the second transducer, and the second receiver generates a second receiving signal to the signal generating circuit. The correlation circuit is configured to perform a correlation operation on the first receiving signal and the second receiving signal to generate a first correlation signal. The processing circuit is configured to generate a TOF variation between the first transducer and the second transducer according to at least the first correlation signal.

One embodiment of the present application discloses a chip, which includes the above-mentioned TOF generating circuit.

One embodiment of the present application discloses a flow meter, which includes the above-mentioned TOF generating circuit; the first transducer; and the second transducer; wherein the TOF generating circuit is coupled to the first transducer and the second transducer.

One embodiment of the present application discloses a TOF generation method for controlling a first transmitter, a first receiver, a second transmitter, and a second receiver, wherein the first transmitter and the first receiver are coupled to a first transducer, and the second transmitter and the second receiver are coupled to a second transducer, wherein there is a distance greater than zero between the first transducer and the second transducer, and the first transducer and the second transducer are arranged in a pipeline filled with fluid. The method includes: under a first ambient factor, generating a first signal to the first transmitter to cause the first transducer to transmit a first transducer signal; after the first transducer signal is received by the second transducer, generating a first receiving signal by using the second receiver; under a second ambient factor, generating a second signal to the first transmitter to cause the first transducer to transmit a second transducer signal; after the second transducer signal is received by the second transducer, generating a second receiving signal by using the second receiver; performing a correlation operation on the first receiving signal and the second receiving signal to generate a first correlation signal; and generating a TOF variation between the first transducer and the second transducer according to at least the first correlation signal.

### BRIEF DESCRIPTION OF THE DRAWINGS

FIG. 1 is a schematic diagram illustrating a TOF generating circuit according to an embodiment of the present application.

FIG. 2 is a schematic diagram illustrating the arrangement of the first transducer and the second transducer according to an embodiment of the present application.

FIG. 3 is a schematic diagram illustrating the operation of the TOF generating circuit under a first ambient factor according to an embodiment of the present application.

FIG. 4 is a schematic diagram illustrating the operation of the TOF generating circuit under a second ambient factor according to an embodiment of the present application.

FIG. 5 is a schematic diagram illustrating the operation of the TOF generating circuit under the second ambient factor according to another embodiment of the present application.

FIG. 6 is a schematic diagram illustrating the operation of the TOF generating circuit under the first ambient factor according to another embodiment of the present application.

FIG. 7 is a schematic diagram illustrating the operation of the TOF generating circuit under the second ambient factor according to another embodiment of the present application.

FIG. 8 is a schematic diagram illustrating the operation of the TOF generating circuit under the first ambient factor according to another embodiment of the present application.

FIG. 9 is a schematic diagram illustrating the operation of the TOF generating circuit under the second ambient factor according to another embodiment of the present application.

FIG. 10 is a flow chart illustrating a TOF generating method according to an embodiment of the present application.

FIG. 11 is a flow chart illustrating the TOF generating method according to another embodiment of the present application.

### DETAILED DESCRIPTION

The following disclosure provides many different embodiments, or examples, for implementing different features of the invention. Specific examples of components and arrangements are described below to simplify the present disclosure. As could be appreciated, these are, of course, merely examples and are not intended to be limiting. For example, the formation of a first feature over or on a second feature in the description that follows may include embodiments in which the first and the second features are formed in direct contact, and may also include embodiments in which additional features may be formed between the first and the second features, such that the first and the second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” and the like, may be used herein for the ease of the description to describe one element or feature's relationship with respect to another element(s) or feature(s) as illustrated in the drawings. The spatially relative terms are intended to encompass different orientations of the device in use or operation in addition to the orientation depicted in the figures. The apparatus may be otherwise oriented (e.g., rotated by 90 degrees or at other orientations) and the spatially relative descriptors used herein may likewise be interpreted accordingly.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. As could be appreciated, other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed considering the number of reported significant digits and by applying ordinary rounding techniques. Ranges can be expressed herein as from one endpoint to another endpoint or between two endpoints. All ranges disclosed herein are inclusive of the endpoints unless specified otherwise.

When calculating the volumetric flux, it is an important issue to determine whether the data detected is reasonable, and then to determine whether the system needs to be calibrated. In some embodiments, the speed of sound can be used as the basis for the determination. For example, the temperature measured by the temperature sensor is applied to the theoretical speed of sound, and compared with the current speed of sound estimated based on the actual measurement result, so as to monitor whether the ultrasonic flowmeter and temperature sensor in the system are operating normally.

In many existing ultrasonic time-of-transmission measurement systems, the signal analysis and calculations in both the upstream and downstream directions are used to obtain information about the information of time-of-flight. However, this approach has several drawbacks, as the two transducers, which are usually placed in the environment where the measurement is performed, are not perfect and usually have a certain degree of offset, and this offset can cause a delay between the upstream signal and the downstream signal. In addition to the delay, there may even be cases where the waveform of the upstream signal differs significantly from that of the downstream signal due to differences between the transfer functions in two directions.

However, if there is a difference between the upstream signal and the downstream signal waveforms, it becomes very complicated to calculate the correlation. Further, the existing measurement systems have a large amount of error, so the correlation is often used to deal with the offset between the two transducers so as to make the upstream signal waveform be substantially identical to the downstream signal waveform. This approach involves adjusting the frequency of the driving transducer or the technical means of impedance matching by using acoustic-electric or electro-acoustic transformation.

The present application proposes a novel approach to eliminate the transducer offset by establishing a reference signal in both of the upstream and downstream directions first, and due to the establishment of the reference signal, the present application can obtain a perfect reference signal by averaging over a long period of time, so that the influence of noise and ambient changes can be greatly reduced, and the resolution of the final measurement can be improved.

The present application provides a TOF generating circuit 100, configured to calculate the signal TOF and the current flow speed of the fluid. The present application further provides a chip, which includes the TOF generating circuit 100. In some embodiments, the TOF generating circuit 100 can be applied in a transducer device; for example, the present application further provides a flow meter, which includes the TOF generating circuit 100, a first transducer 102, and a second transducer 104. For example, the above-mentioned flow meter can be configured to detect the flow speed and/or the volumetric flux of gas and liquid; however, the present application is not limited thereto.

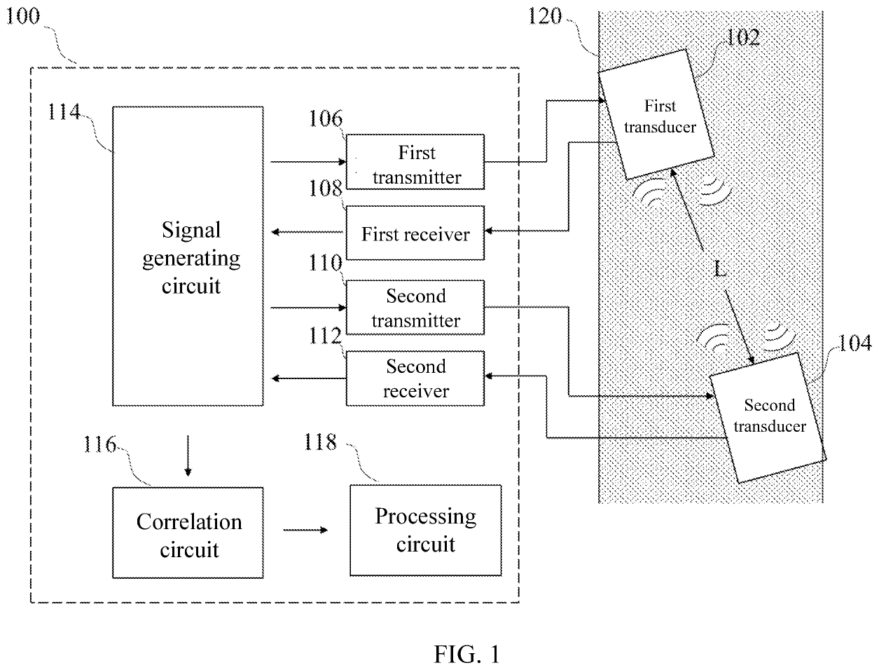

FIG. 1 is a schematic diagram illustrating the TOF generating circuit 100 applied in the embodiment of the flow meter. The TOF generating circuit 100 is coupled to the first transducer 102 and the second transducer 104. The transducer is a component capable of transforming energy in one form into another form. These energy forms may include the forms of electric energy, mechanic energy, electromagnetic energy, solar energy, chemical energy, acoustic energy, and thermal energy, etc.; however, the present application is not limited thereto, and the transducer may include any component capable of transforming energy.

The first transducer 102 and second transducer 104 are installed in a pipeline 120 filled with fluid (e.g., liquid or gas). The transmission direction of the first transducer 102 faces the second transducer 104; and the transmission direction of the second transducer 104 faces the first transducer 102. There is a distance L between the first transducer 102 and the second transducer 104, and L is greater than zero.

The TOF generating circuit 100 includes a first transmitter 106 and a first receiver 108, both of which are coupled to the first transducer 102; and a second transmitter 110 and a second receiver 112, both of which are coupled to the second transducer 104. The TOF generating circuit 100 further includes a signal generating circuit 114, a correlation circuit 116, and a processing circuit 118, configured to generate the TOF of the signal in the fluid by signal processing, and further estimate the flow speed of the fluid. Specifically, the correlation circuit 116 is configured to perform a correlation operation on the signals, whereas the processing circuit 118 is configured to calculate the TOF of the signal in the fluid and the flow speed of the fluid according to the signal that has been subject to the correlation operation. In some embodiments, the processing circuit 118 is further configured to calculate the volumetric flux of the fluid according to the flow speed of the fluid.

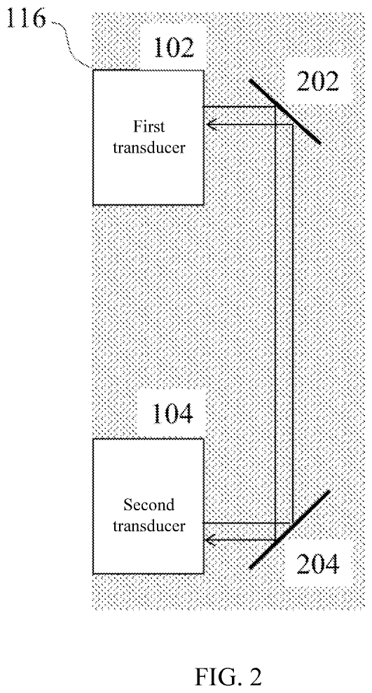

It should be noted that the arrangement and position of the first transducer 102 and the second transducer 104 in the pipeline 120 are not limited to those shown in FIG. 1. FIG. 2 is a schematic diagram illustrating the arrangement of the first transducer 102 and the second transducer 104 in the pipeline 120 according to an embodiment of the present application. In the embodiment of FIG. 2, reflective plates 202 and 204 are arranged in the pipeline 120 and configured to reflect the signal transmitted by the first transducer 102 to the second transducer 104 and reflect the signal transmitted by the second transducer 104 to the first transducer 102. In this embodiment, the distance L between the first transducer 102 and the second transducer 104 shall be considered as the distance passed by the signal; in other words, the distance L is the distance starting from the first transducer 102 to the second transducer 104 through the reflective plates 202 and 204. In the following drawings, the positions of the first transducer 102 and the second transducer 104 are illustrated in the same way as those shown in FIG. 1, for the sake of brevity.

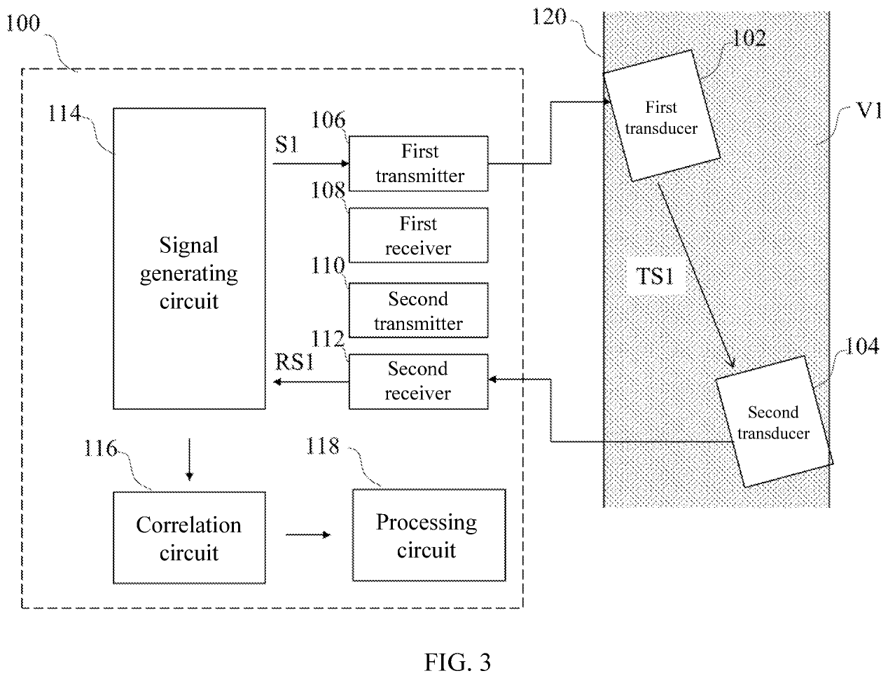

FIG. 3 is a schematic diagram illustrating the operation of the TOF generating circuit 100 under the first ambient factor according to an embodiment of the present application. In this embodiment, the fluid has a first flow speed V1 under the first ambient factor. In some embodiments, the first flow speed V1 is zero; in other words, the fluid is still. The signal generating circuit 114 generates a first signal S1 to the first transmitter 106 to cause the first transducer 102 to transmit a first transducer signal TS1, wherein the first transducer signal TS1 is received by the second transducer 104, and the second receiver 112 generates a first receiving signal RS1 to the signal generating circuit 114.

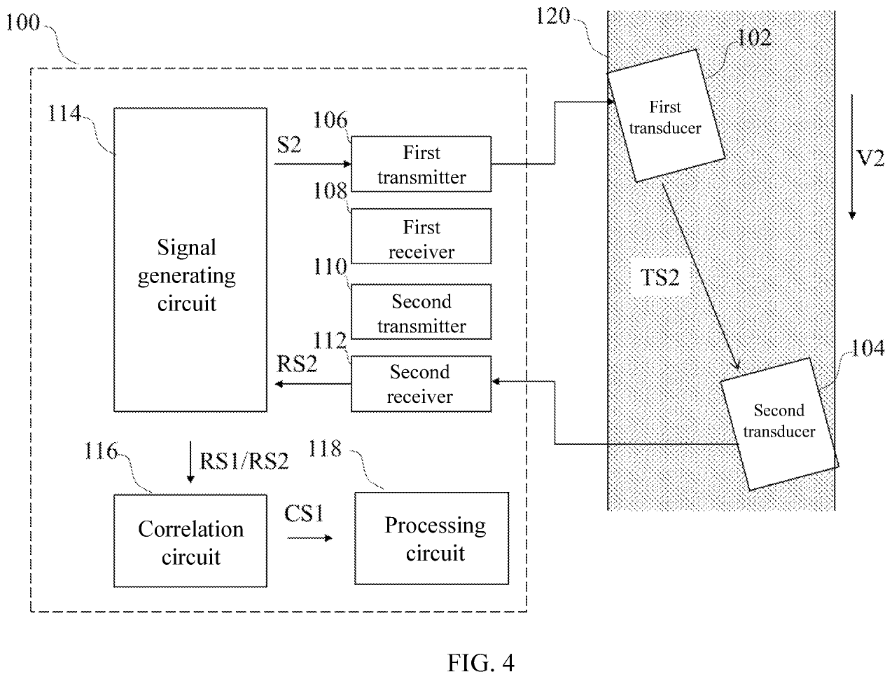

Following the embodiment in FIG. 3, FIG. 4 is a schematic diagram illustrating the operation of the TOF generating circuit 100 under the second ambient factor according to an embodiment of the present application. In this embodiment, the fluid has a second flow speed V2 under the second ambient factor. The signal generating circuit 114 further generates a second signal S2 to the first transmitter 106 to cause the first transducer 102 to transmit a second transducer signal TS2, wherein the second transducer signal TS2 is received by the second transducer 104, and the second receiver 112 generates a second receiving signal RS2 to the signal generating circuit 114. Next, the signal generating circuit 114 transmits the first receiving signal RS1 and the second receiving signal RS2 to the correlation circuit 116. The correlation circuit 116 performs the correlation operation on the first receiving signal RS1 and second receiving signal RS2 in a time domain to generate a first correlation signal CS1. Persons having ordinary skill in the art should understand that performing the correlation operation on the first receiving signal RS1 and the second receiving signal RS2 in the time domain is to find a position where the two signals having the maximum value in the time axis. However, because the resolution of the time axis is not infinite, the maximum value is usually found by interpolating several values, and the maximum value is the TOF value. It should be noted that the present application is not limited to performing correlation operations in the time domain. In other embodiments, the correlation circuit 116 may first perform fast Fourier transform on the first receiving signal RS1 and the second receiving signal RS2 to generate a first transformation signal and a second transformation signal in the frequency domain, and then perform the correlation operation on the first transformation signal and the second transformation signal to obtain the first correlation signal CS1. Those having ordinary skill in the art should understand the correlation operation performed on the first transformation signal and the second transformation signal in the frequency domain can be expressed as H*(f)·H(f)·G(f), in which G is one of the first transformation signal and the second transformation signal, H is the other of the first transformation signal and the second transformation signal, * represents the complex conjugate, and the result obtained is the phase response; hence, the TOF value can be obtained by obtaining the slope from the result of the phase response.

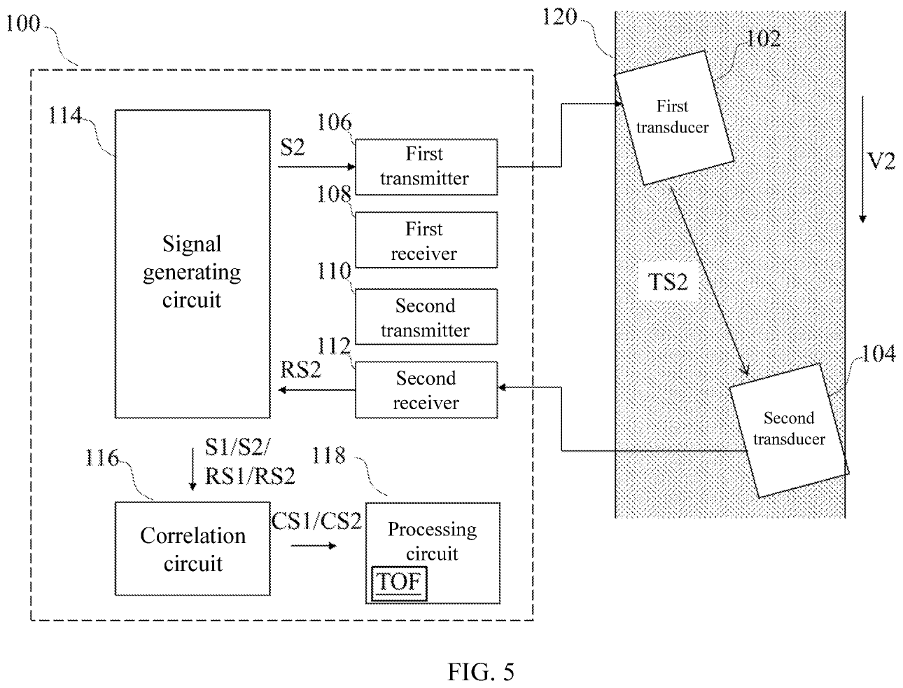

Following the embodiment in FIG. 4, FIG. 5 is a schematic diagram illustrating the operation of the TOF generating circuit 100 under the second ambient factor according to another embodiment of the present application. In this embodiment, the signal generating circuit 114 further transmits the first signal S1 and the second signal S2 to the correlation circuit 116. The correlation circuit 116 further performs the correlation operation on the first signal S1 and the second signal S2 to generate a second correlation signal CS2. Next, the processing circuit 118 generates the TOF according to the first correlation signal CS1 and the second correlation signal CS2. Optionally, the processing circuit 118 may further calculate the volumetric flux of the fluid according to the TOF.

More specifically, in the embodiment of FIG. 3, the actual TOF of the first transducer signal TS1 (from the first transducer 102 to the second transducer 104) under the first ambient factor is assumed to be TOF₁, and the TOF₁ can be further expressed as:

TOF₁=L/C,

in which L is the distance of the path traveled by the first transducer signal TS1, C is the speed of the signal transmission, and the flow speed V1 of the fluid is assumed to be zero, whereas the process offset parameter of the first transmitter 106 is ε₁, and the process offset parameter of the second receiver 112 is ε₂. Hence, the TOF_{1, generate} measured by the processing circuit 118 will be:

TOF_{1,generate}=ε₁+ε₂+TOF₁;

in the embodiment of FIG. 4, the actual TOF of the second transducer signal TS2 (from the first transducer 102 to the second transducer 104) is assumed to be TOF₂, and the TOF₂ may be further expressed as:

TOF₂=L/(C+V2),

in which L is the distance of the path traveled by the first transducer signal TS2, C is the speed of the signal transmission, and V2 is the flow speed of the fluid, whereas the process offset parameter of the first transmitter 106 is ε₁, and the process offset parameter of the second receiver 112 is ε₂. Hence, the TOF_{2, generate} measured by the processing circuit 118 will be:

TOF_{2,generate}=ε₁+ε₂+TOF₂,

therefore, the following equation can be obtained:

TOF_{2,generate}−TOF_{1,generate}=TOF₂−TOF₁=[L/(C+V2)]−L/C,

under the condition that the TOF_{2, generate} and the TOF_{1, generate} generated by the processing circuit 118, the distance L, and the speed C of signal transmission are known, the flow speed V2 of the fluid can be obtained easily, and the effect of the process offset parameters of the first transmitter 106 and the second receiver 112 can be removed. Thereby, the accuracy of the measurement is improved. In the present embodiment, the first transducer signal TS1 and the second transducer signal TS2 are acoustic signals, and hence the speed C of signal transmission is the speed of sound.

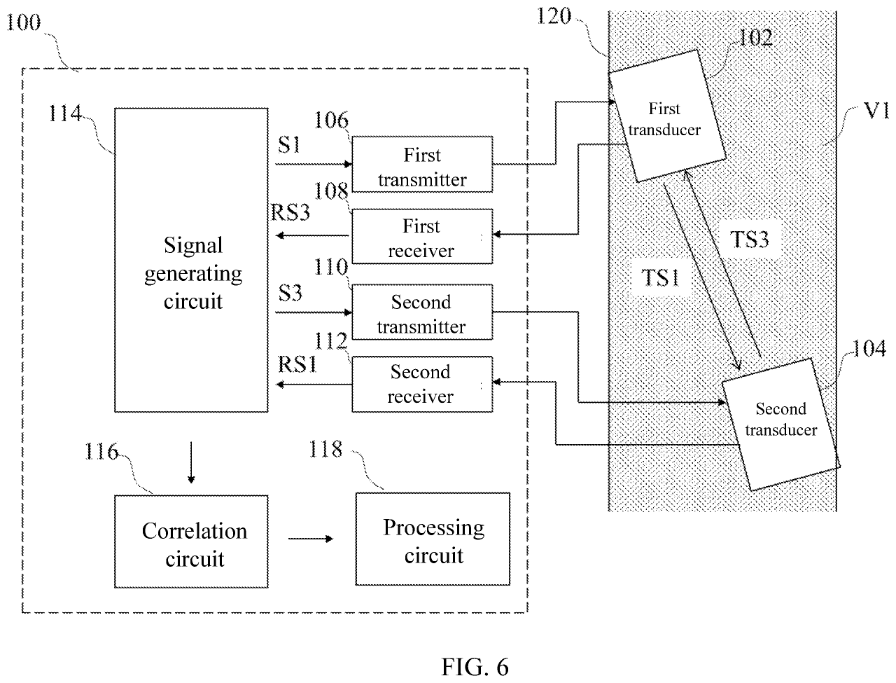

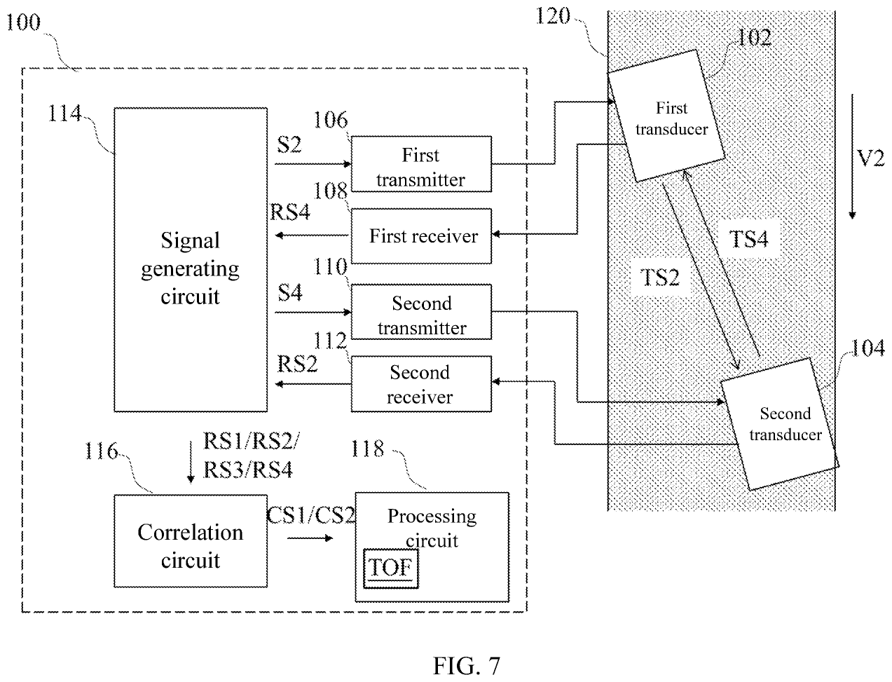

Following the embodiment in FIG. 3, FIG. 6 is a schematic diagram illustrating the operation of the TOF generating circuit 100 under the first ambient factor according to another embodiment of the present application. In this embodiment, the signal generating circuit 114 further generates a third signal S3 to the second transmitter 110 to cause the second transducer 104 to transmit a third transducer signal TS3, wherein the third transducer signal TS3 is received by the first transducer 102, and the first receiver 108 generates a third receiving signal RS3 to the signal generating circuit 114. It should be noted that the present application is not particularly limited the time sequence of the generation of the first signal S1 and the third signal S3; in other words, in the embodiment of FIG. 6, the signal generating circuit 114 may first generate the first signal S1 to the first transmitter 106 to cause the first transducer 102 to transmit the first transducer signal TS1, wherein the first transducer signal TS1 is received by the second transducer 104, and the second receiver 112 generates the first receiving signal RS1 to the signal generating circuit 114. Next, the signal generating circuit 114 may generate the third signal S3 to the second transmitter 110 to cause the second transducer 104 to transmit the third transducer signal TS3, wherein the third transducer signal TS3 is received by the first transducer 102, and the first receiver 106 generates the third receiving signal RS3 to the signal generating circuit 114. Alternatively, the signal generating circuit 114 may first generate the third signal S3 to the second transmitter 110 to cause the second transducer 104 to transmit the third transducer signal TS3, wherein the third transducer signal TS3 is received by the first transducer 102, and the first receiver 106 generates the third receiving signal RS3 to the signal generating circuit 114. Next, the signal generating circuit 114 generates the first signal S1 to the first transmitter 106 to cause the first transducer 102 to transmit the first transducer signal TS1, wherein the first transducer signal TS1 is received by the second transducer 104, and the second receiver 112 generates the first receiving signal RS1 to the signal generating circuit 114. Still alternatively, the signal generating circuit 114 simultaneously generates the first signal S1 and the third signal S3 to the first transmitter 106 and the second transmitter 110 to cause the first transducer 102 and the second transducer 104 to transmit signals to the second receiver 112 and first receiver 108, respectively (please see the embodiment illustrated in FIG. 7).

Following the embodiment in FIG. 6, FIG. 7 is a schematic diagram illustrating the operation of the TOF generating circuit 100 under the second ambient factor according to another embodiment of the present application. In this embodiment, the signal generating circuit 114 generates a second signal S2 to the first transmitter 106 to cause the first transducer 102 to transmit a second transducer signal TS2, wherein the second transducer signal TS2 is received by the second transducer 104, and the second receiver 112 generates the second receiving signal RS2 to the signal generating circuit 114. Further, the signal generating circuit 114 generates a fourth signal S4 to the second transmitter 110 to cause the second transducer 104 to transmit a fourth transducer signal TS4, wherein the fourth transducer signal TS4 is received by the first transducer 102, and the first receiver 108 generates a fourth receiving signal RS4 to the signal generating circuit 114. Similarly, the present application is not particularly limited to the time sequence of the generation of the second signal S2 and the fourth signal S4.

Next, the signal generating circuit 114 transmits the first receiving signal RS1, the second receiving signal RS2, the third receiving signal RS3, and the fourth receiving signal RS4 to the correlation circuit 116. The correlation circuit 116 performs the correlation operation on the first receiving signal RS1 and the second receiving signal RS2 in the time domain to generate the first correlation signal CS1 and performs the correlation operation on the third receiving signal RS3 and the fourth receiving signal RS4 in the time domain to generate the second correlation signal CS2. The processing circuit 118 calculates the TOF according to the first correlation signal CS1 and the second correlation signal CS2. Similarly, the correlation circuit 116 may first perform fast Fourier transform on the first receiving signal RS1, the second receiving signal RS2, the third receiving signal RS3 and the fourth receiving signal RS4 to respectively obtain the first transformation signal, the second transformation signal, the third transformation signal, and the fourth transformation signal, and perform the correlation operation on the first transformation signal and the second transformation signal and perform the correlation operation on the third transformation signal and the fourth transformation signal to respectively obtain the first correlation signal and the second correlation signal. Optionally, the processing circuit 118 may further calculate the volumetric flux of the fluid according to the TOF.

It should be noted that signal generating circuit 114 further includes an storage device (not shown in the drawing), configured to store the first receiving signal RS1, the second receiving signal RS2, the third receiving signal RS3, and the fourth receiving signal RS4. In some embodiments, the storage device may be arranged independently from the signal generating circuit 114. Further, the present application is not particularly limited to generating only one first receiving signal RS1 and only one third receiving signal RS3. In other embodiments, the signal generating circuit 114 may, under the first ambient factor, generate a plurality of first receiving signals RS and a plurality of third receiving signals RS3, which are stored in the storage device. Next, the signal generating circuit 114 performs equivalent averaging on the plurality of first receiving signal RS1, and similarly, performs equivalent averaging on the plurality of third receiving signal RS3. In this way, the noise of the system can be eliminated effectively.

More specifically, in the embodiment of FIG. 6, the actual TOF of the first transducer signal TS1 (from the first transducer 102 to the second transducer 104) under the first ambient factor is assumed to be TOF₁, and the TOF₁ may be further expressed as:

TOF₁=L/C,

in which L is the distance of the path traveled by the first transducer signal TS1, C is the speed of the signal transmission, and the flow speed V1 of the fluid is assumed to be zero, whereas the process offset parameter of the first transmitter 106 is ε₁, and the process offset parameter of the second receiver 112 is ε₂. Hence, the TOF_{1, generate} measured by the processing circuit 118 will be:

TOF_{1,generate}=ε₁+ε₂+TOF₁;

further, the actual TOF of the third transducer signal TS3 (from the second transducer 104 to the first transducer 102) is TOF₃, and the TOF₃ may also be expressed as TOF₃=L/C, whereas the process offset parameter of the second transmitter 110 is E3 and the process offset parameter of the first receiver 108 is ε₄. Hence, the TOF_{3, generate} measured by the processing circuit 118 will be:

TOF_{3,generate}=ε₃+ε₄+TOF₃.

Next, in the embodiment of FIG. 7, the actual TOF of the second transducer signal TS2 (from the first transducer 102 to the second transducer 104) under the second ambient factor is assumed to be TOF₂. The process offset parameter of the first transmitter 106 is ε₁ and the process offset parameter of the second receiver 112 is ε₂, and hence, the TOF_{2, generate} measured by the processing circuit 118 will be:

TOF_{2,generate}=ε₁+ε₂+TOF₂,

wherein the TOF₂ may be further expressed as:

TOF₂=L/(C+V2),

in which L is the distance of the path traveled by the second transducer signal TS2, C is the speed of the signal transmission, and V2 is the flow speed of the fluid; further, the actual TOF of the fourth transducer signal TS4 (from the second transducer 104 to the first transducer 102) is TOF₄, wherein the TOF₄ may also be expressed as:

TOF₄=L/(C−V2),

whereas the process offset parameter of the second transmitter 110 is ε₃, and the process offset parameter of the first receiver 108 is ε₄; hence the TOF_{4, generate} measured by the processing circuit 118 will be:

TOF_{4,generate}=ε₃+ε₄+TOF₄.

Therefore, the following equations can be obtained:

TOF_{2,generate}−TOF_{1,generate}=TOF₂−TOF₁=[L/(C+V2)]−L/C,

TOF_{4,generate}−TOF_{3,generate}=TOF₄−TOF₃=[L/(C−V2)]−L/C.

Under the condition that the TOF_{1, generate}, the TOF_{2, generate}, the TOF_{3, generate} and the TOF_{4, generate} generated by the processing circuit 118, the distance L, and the speed C of signal transmission are known, the flow speed V2 of the fluid can be obtained easily, and the effect of the process offset parameters of the first transmitter 106, the first receiver 108, the second transmitter 110, and the second receiver 112 can be removed. Thereby, the accuracy of the measurement is improved. In the present embodiment, the first transducer signal TS1, the second transducer signal TS2, the third transducer signal TS3, and the second transducer signal TS4 are acoustic signals, and hence the speed C of signal transmission is the speed of sound.

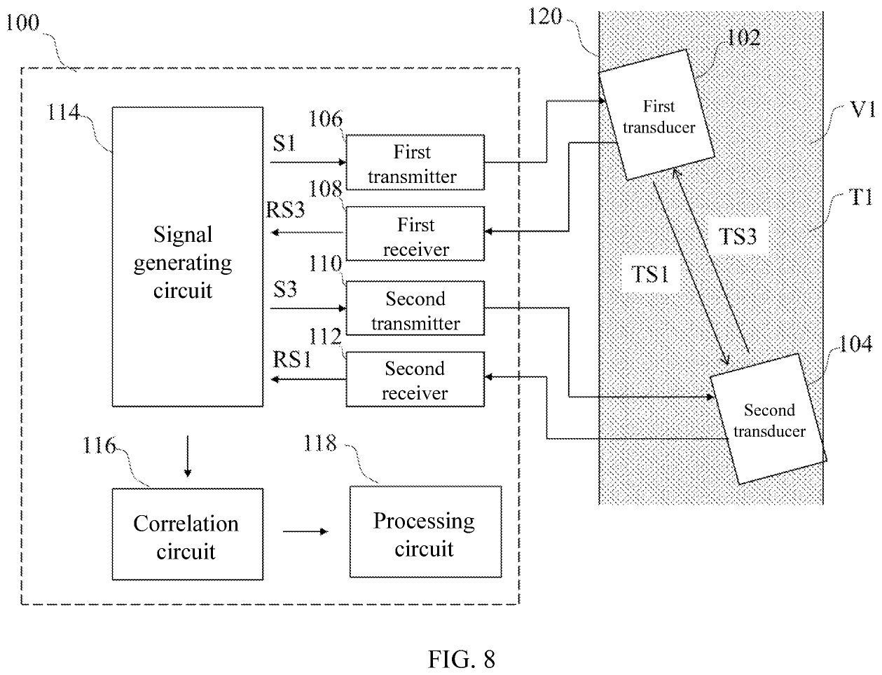

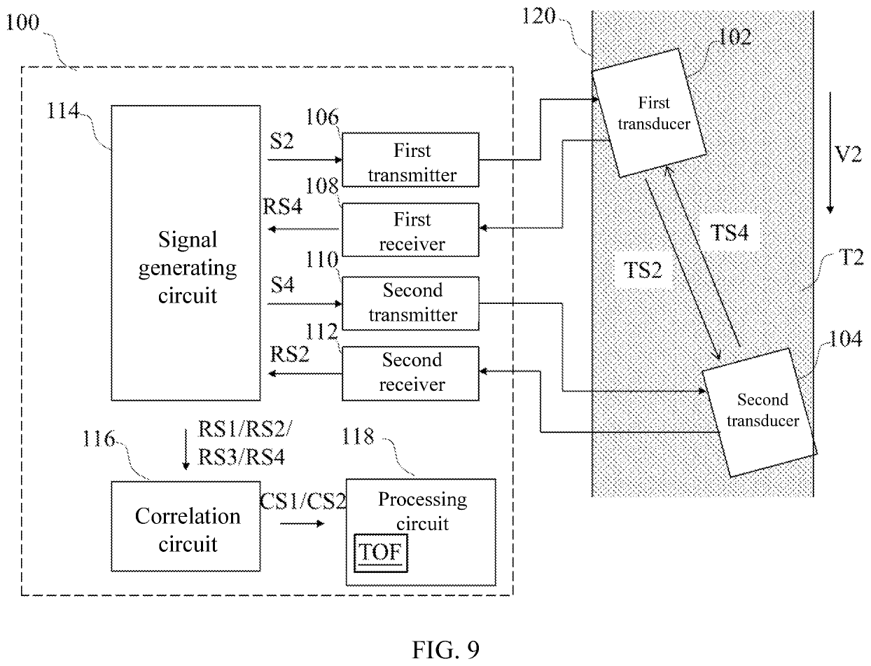

It should be noted that, in the above-mentioned embodiments, the first ambient factor and the second ambient factor respectively represent the fluid having a different flow speed (such as V1 and V2, wherein V1 is 0); however, the present application is not limited thereto. In other embodiments, the first ambient factor and the second ambient factor may respectively represent different ambient temperatures. FIG. 8 and FIG. 9 are schematic diagrams illustrating the operation of the TOF generating circuit 100 under the first ambient factor and the second ambient factor according to an embodiment of the present application. The embodiment shown in FIG. 8 is similar to the embodiment shown in FIG. 6, except that in the embodiment shown in FIG. 8, the ambient temperature within the pipeline 120 is T; whereas embodiment shown in FIG. 9 is similar to the embodiment shown in FIG. 7, except that in the embodiment shown in FIG. 9, the ambient temperature within the pipeline 120 is T2.

More specifically, in the embodiment of FIG. 8, the actual TOF of the first transducer signal TS1 (from the first transducer 102 to the second transducer 104) under the first ambient factor is assumed to be TOF₁, and the TOF₁ may be further expressed as:

TOF₁=L/C₁,

in which L is the distance of the path traveled by the first transducer signal TS1, C₁ is the speed of the signal transmission under the ambient temperature T1, and the flow speed V1 of the fluid is assumed to be zero, whereas the process offset parameter of the first transmitter 106 under the ambient temperature T1 is ε₁, and the process offset parameter of the second receiver 112 under the ambient temperature T1 is ε₂; and hence, the TOF_{1, generate} measured by the processing circuit 118 will be:

TOF_{1,generate}=ε₁+ε₂+TOF₁;

further, the actual TOF of the third transducer signal TS3 (from the second transducer 104 to the first transducer 102) is TOF₃, and the TOF₃ may also be expressed as TOF₃=L/C,

TOF₃=L/C₁,

whereas the process offset parameter of the second transmitter 110 under the ambient temperature T1 is ε₃ and the process offset parameter of the first receiver 108 under the ambient temperature T1 is ε₄, and hence, the TOF_{3, generate} measured by the processing circuit 118 will be:

TOF_{3,generate}=ε₃+ε₄+TOF₃.

Next, in the embodiment of FIG. 9, the actual TOF of the first transducer signal TS2 (from the first transducer 102 to the second transducer 104) under the second ambient factor is assumed to be TOF₂, and the TOF₂ may be further expressed as:

TOF₂=L/(C₂+V2),

in which C₂ is the speed of the signal transmission under the ambient temperature T2, whereas the process offset parameter of the first transmitter 106 under the ambient temperature T2 is ε₁′, and the process offset parameter of the second receiver 112 under the ambient temperature T2 is ε₂′, and hence, the TOF_{2, generate} measured by the processing circuit 118 will be:

TOF_{2,generate}=ε₁′+ε₂′+TOF₂;

further, the actual TOF of the fourth transducer signal TS4 (from the second transducer 104 to the first transducer 102) is TOF₄, and the TOF₄ can also be expressed as:

TOF₄=L/(C₂−V2),

whereas the process offset parameter of the second transmitter 110 is ε₃, and the process offset parameter of the first receiver 108 is ε₄′, and hence the TOF_{4, generate} measured by the processing circuit 118 will be

TOF_{4,generate}=ε₃′+ε₄′+TOF₄.

Therefore, the following equations can be obtained:

TOF_{2,generate}−TOF_{1,generate}=TOF₂−TOF₁+Δε_{1,2}=[L/(C₂+V2)]−L/C₁,

TOF_{4,generate}−TOF_{3,generate}=TOF₄−TOF₃+Δε_{3,4}=[L/(C₂−V2)]−L/C₁.

Under the condition that the TOF_{1, generate}, the TOF_{2, generate}, the TOF_{3, generate} and the TOF_{4, generate} generated by the processing circuit 118, the distance L, and the speed of signal transmission C₂ are known, although there might still be a certain process offset parameters such as Δε_{1,2} and Δε_{3,4}, but the Δε_{1,2} and Δε_{3,4} are results obtained by subtraction, therefore, the error of the flow speed V2 of the fluid obtained is smaller than the one obtained without using the techniques proposed by the present application. Hence, the accuracy of the measurement is improved. In the present embodiment, the first transducer signal TS1, the second transducer signal TS2, the third transducer signal TS3, and the second transducer signal TS4 are acoustic signals, and hence the speed C of signal transmission is the speed of sound.

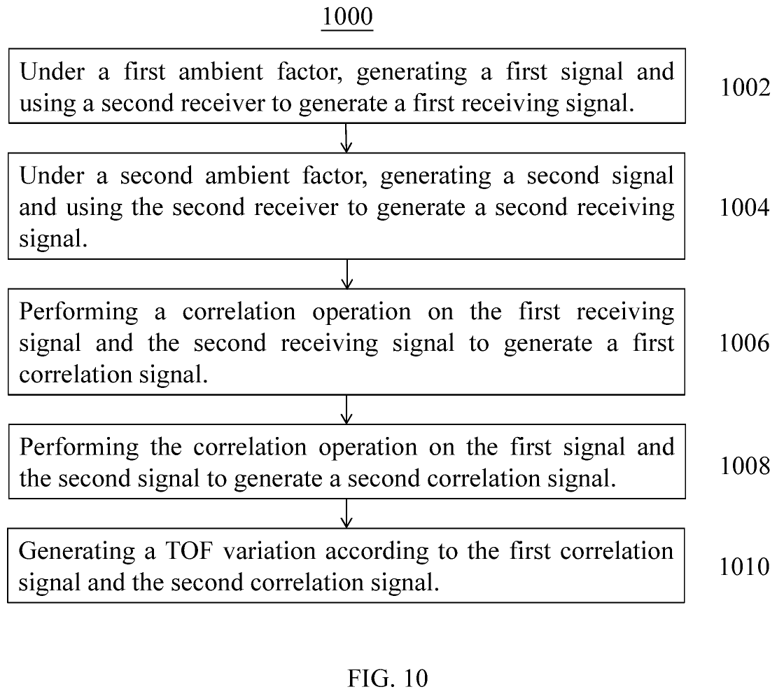

FIG. 10 is a flow chart illustrating a TOF generation method 1000 according to an embodiment of the present application. The present application is not limited to all the steps shown in FIG. 10, if substantially the same result can be achieved. The method 1000 is summarized as follows:
Step 1002: under a first ambient factor, generating a first signal and using a second receiver to generate a first receiving signal.
Step 1004: under a second ambient factor, generating a second signal and using the second receiver to generate a second receiving signal.
Step 1006: performing a correlation operation on the first receiving signal and the second receiving signal to generate a first correlation signal.
Step 1008: performing the correlation operation on the first signal and the second signal to generate a second correlation signal.
Step 1010: generating a TOF variation according to the first correlation signal and the second correlation signal.

Persons having ordinary skill in the art can readily understand the details of the TOF generation method 1000, upon reading embodiments of FIG. 3, FIG. 4, and FIG. 5, and hence a detailed description thereof is omitted herein for the sake of brevity.

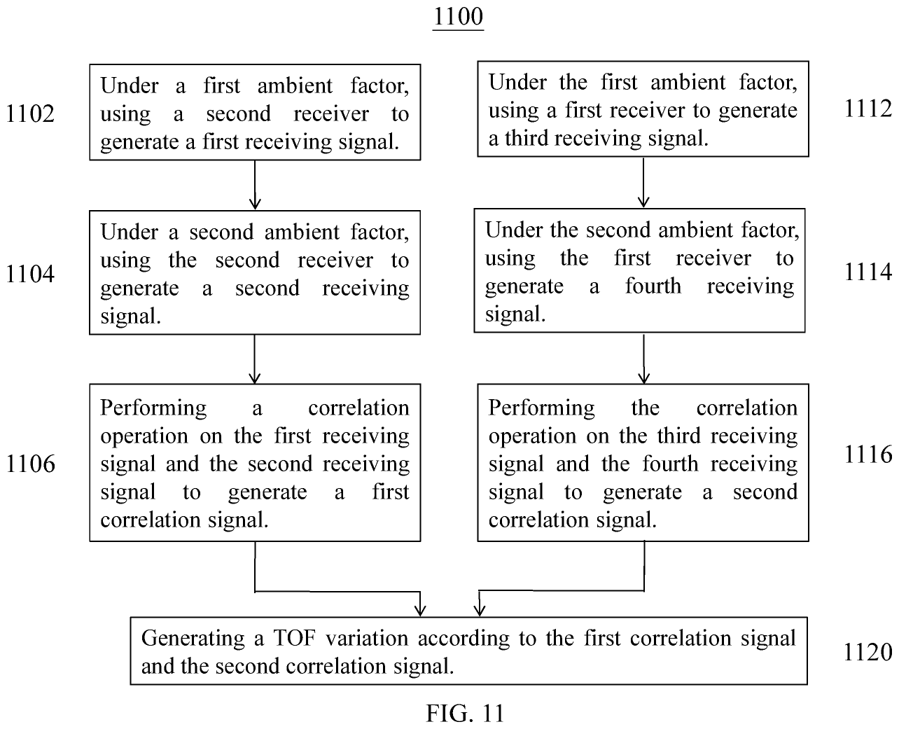

FIG. 11 is a flow chart illustrating the TOF generation method 1100 according to another embodiment of the present application. The present application is not limited to all the steps shown in FIG. 11, if substantially the same result can be achieved. The method 1100 is summarized as follows:
Step 1102: under a first ambient factor, using a second receiver to generate a first receiving signal.
Step 1104: under a second ambient factor, using the second receiver to generate a second receiving signal.
Step 1106: performing a correlation operation on the first receiving signal and the second receiving signal to generate a first correlation signal.
Step 1112: under the first ambient factor, using a first receiver to generate a third receiving signal.
Step 1114: under the second ambient factor, using the first receiver to generate a fourth receiving signal.
Step 1116: performing the correlation operation on the third receiving signal and the fourth receiving signal to generate a second correlation signal.
Step 1120: generating a TOF variation according to the first correlation signal and the second correlation signal.

Persons having ordinary skill in the art can readily understand the details of the TOF generation method 1100, upon reading embodiments of FIG. 3, FIG. 6, and FIG. 7, and hence a detailed description thereof is omitted herein for the sake of brevity.

The foregoing outlines the features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of embodiments introduced herein. Those skilled in the art should also realize that such equivalent embodiments still fall within the spirit and scope of the present disclosure, and they may make various changes, substitutions, and alterations thereto without departing from the spirit and scope of the present disclosure.

What is claimed is:

1. A time-of-flight (TOF) generating circuit, coupled to a first transducer and a second transducer, wherein there is a distance greater than zero between the first transducer and the second transducer, and the first transducer and the second transducer are arranged in a pipeline filled with fluid, characterized by comprising:
a first transmitter, coupled to the first transducer;
a first receiver, coupled to the first transducer;
a second transmitter, coupled to the second transducer;
a second receiver, coupled to the second transducer;
a signal generating circuit, configured to, under the first ambient factor, generate a first signal to the first transmitter to cause the first transducer to transmit a first transducer signal, wherein the first transducer signal is received by the second transducer, and the second receiver generates a first receiving signal to the signal generating circuit; and, under a second ambient factor, generate a second signal to the first transmitter to cause the first transducer to transmit a second transducer signal, wherein the second transducer signal is received by the second transducer receives and the second receiver generates a second receiving signal to the signal generating circuit;
a correlation circuit, configured to perform a correlation operation on the first receiving signal and the second receiving signal to generate a first correlation signal; and
a processing circuit, configured to generate a TOF variation between the first transducer and the second transducer according to at least the first correlation signal.

2. The TOF generating circuit of claim 1, characterized in that the correlation circuit is further configured to perform the correlation operation on the first signal and the second signal to generate a second correlation signal.

3. The TOF generating circuit of claim 1, characterized in that the signal generating circuit is further configured to, under the first ambient factor, generate a third signal to the second transmitter to cause the second transducer to transmit a third transducer signal, wherein the third transducer signal is received by the first transducer, and the first receiver generates a third receiving signal to the signal generating circuit; and, under a second ambient factor, generate a fourth signal to the second transmitter to cause the second transducer to transmit a fourth transducer signal, wherein the fourth transducer signal is received by the first transducer, and the first receiver generates a fourth receiving signal to the signal generating circuit.

4. The TOF generating circuit of claim 3, characterized in that the correlation circuit is further configured to perform the correlation operation on the third receiving signal and the fourth receiving signal to generate a second correlation signal.

5. The TOF generating circuit of claim 2, characterized in that the processing circuit generates the TOF variation between the first transducer and the second transducer according to the first correlation signal and the second correlation signal.

6. The TOF generating circuit of claim 1, characterized in that, under the first ambient factor, the fluid has a first flow speed, and, under the second ambient factor, the fluid has a second flow speed.

7. The TOF generating circuit of claim 1, characterized in that, under the first ambient factor, the TOF generating circuit is at an environment having a first temperature, and, under the second ambient factor, the TOF generating circuit is at an environment having a second temperature.

8. The TOF generating circuit of claim 1, characterized in that the correlation operation comprises performing a fast Fourier transform on the first receiving signal and the second receiving signal to generate a first transformation signal and a second transformation signal, respectively, and calculating a correlation on the first transformation signal and the second transformation signal to generate the first correlation signal.

9. The TOF generating circuit of claim 1, characterized in that the processing circuit is further configured to calculate a volumetric flux of the fluid according to the TOF.

10. A chip, characterized by comprising:
a time-of-flight (TOF) generating circuit, coupled to a first transducer and a second transducer, wherein there is a distance greater than zero between the first transducer and the second transducer, and the first transducer and the second transducer are arranged in a pipeline filled with fluid, the time-of-flight (TOF) generating circuit comprising:
a first transmitter, coupled to the first transducer;
a first receiver, coupled to the first transducer;
a second transmitter, coupled to the second transducer;
a second receiver, coupled to the second transducer;
a signal generating circuit, configured to, under the first ambient factor, generate a first signal to the first transmitter to cause the first transducer to transmit a first transducer signal, wherein the first transducer signal is received by the second transducer, and the second receiver generates a first receiving signal to the signal generating circuit; and, under a second ambient factor, generate a second signal to the first transmitter to cause the first transducer to transmit a second transducer signal, wherein the second transducer signal is received by the second transducer receives and the second receiver generates a second receiving signal to the signal generating circuit;
a correlation circuit, configured to perform a correlation operation on the first receiving signal and the second receiving signal to generate a first correlation signal; and
a processing circuit, configured to generate a TOF variation between the first transducer and the second transducer according to at least the first correlation signal.

11. A flow meter, characterized by comprising:
the TOF generating circuit of any of claim 1;
a first transducer; and
a second transducer;
wherein the TOF generating circuit is coupled to the first transducer and the second transducer.

12. A TOF generation method, configured to control a first transmitter, a first receiver, a second transmitter, and a second receiver, wherein the first transmitter and the first receiver are coupled to a first transducer, and the second transmitter and the second receiver are coupled to a second transducer, wherein there is a distance greater than zero between the first transducer and the second transducer, and the first transducer and the second transducer are arranged in a pipeline filled with fluid, characterized by comprising:
under a first ambient factor, generating a first signal to the first transmitter to cause the first transducer to transmit a first transducer signal;
after the first transducer signal is received by the second transducer, generating a first receiving signal by using the second receiver;
under a second ambient factor, generating a second signal to the first transmitter to cause the first transducer to transmit a second transducer signal;
after the second transducer signal is received by the second transducer, generating a second receiving signal by using the second receiver;
performing a correlation operation on the first receiving signal and the second receiving signal to generate a first correlation signal; and
generating a TOF variation between the first transducer and the second transducer according to at least the first correlation signal.

13. The TOF generation method of claim 12, characterized by further comprising:
performing the correlation operation on the first signal and the second signal to generate a second correlation signal.

14. The TOF generation method of claim 12, characterized by further comprising:
under the first ambient factor, generating a third signal to the second transmitter to cause the second transducer to transmit a third transducer signal;
after the third transducer signal is received by the first transducer, generating a third receiving signal by using the first receiver;
under the second ambient factor, generating a fourth signal to the second transmitter to cause the second transducer to transmit a fourth transducer signal; and
after the fourth transducer signal is received by the first transducer, generating a fourth receiving signal by using the first receiver.

15. The TOF generation method of claim 14, characterized by further comprising:
performing the correlation operation on the third receiving signal and the fourth receiving signal to generate a second correlation signal.

16. The TOF generation method of claim 13, characterized in that generating the TOF variation between the first transducer and the second transducer according to at least the first correlation signal comprises:
generating a signal indicating the TOF variation between the first transducer and the second transducer according to the first correlation signal and the second correlation signal.

17. The TOF generation method of claim 12, characterized in that, under the first ambient factor, the fluid has a first flow speed, and, under the second ambient factor, the fluid has a second flow speed.

18. The TOF generation method of claim 12, characterized in that, under the first ambient factor, the first transducer and the second transducer are at an environment having a first temperature, and, under the second ambient factor, the first transducer and the second transducer are at an environment having a second temperature.

19. The TOF generation method of claim 12, characterized in that the correlation operation comprises:
performing a fast Fourier transform on the first receiving signal and the second receiving signal to generate a first transformation signal and a second transformation signal, respectively; and
performing a correlation on the first transformation signal and the second transformation signal to generate the first correlation signal.

20. The TOF generation method of claim 12, characterized by further comprising:
calculating a volumetric flux of the fluid according to the TOF.
